(19) United States
(12) Patent Application Publication
(10) Pub. No.: US 2007/0132546 A1
(43) Pub. Date: Jun. 14, 2007

(54) Service providing apparatus, service providing program, computer-readable recording medium, service providing method, and key unit

(75) Inventors: Akihiko Nakamura, Kyoto-shi (JP); Masayuki Oyagi, Kyoto (JP); Masaki Yamato, Kyoto-shi (JP); Atsushi Hisano, Kyoto-shi (JP); Hideyuki Kobayashi, Kyoto (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 10/577,924

(22) PCT Filed: Oct. 29, 2004
(86) PCT No.: PCT/JP04/16152

§ 371 Date: Nov. 9, 2006

(30) Foreign Application Priority Data
Nov. 7, 2003 (JP) 2003-378808

(51) Int. Cl. G08B 25/00; G08B 13/08

(52) U.S. Cl. 340/5.3; 382/115; 340/545.1

(57) ABSTRACT

A crime prevention system includes an operation sensor 3 that judges whether a user has operated an access point in an object of operation by a user, an ID authentication processing unit 21 that performs ID authentication for the user on the basis of a result of the judgment of the operation sensor 3, and an external processing determining unit 22 that causes an external apparatus to execute a service corresponding to a result of the ID authentication of the ID authentication processing unit 21.

### TECHNICAL FIELD

The present invention relates to a service providing system that can provide a user with an optimum service using ID authentication.

1. Background Art

In a field related to a crime prevention system which is an example of a service providing system, various crime prevention methods have been proposed. Among the crime prevention methods, a method particularly frequently proposed is a method of performing crime prevention using a monitoring camera.

For example, a Patent Document 1 (JP-A-2003-199088, laid open on Jul. 11, 2003) discloses a crime prevention system including, as shown in FIG. 8, a constitution that includes a photographing apparatus 100, a house side terminal 120 that transmits video information photographed by the photographing apparatus 100 to the Internet 110, and a host computer 140 that receives the video information from the Internet 110 and transmits the video information to the mobile terminal 130. In the crime prevention system, when the house side terminal 120 or the host computer 140 acquires a visitor or the like, video information is transmitted from the host computer 140 to the mobile terminal 130.

A Patent Document 2 (JP-A-2002-312865, laid open on Oct. 2002) discloses a crime prevention system in which, as shown in FIG. 9, when a human detecting device such as an infrared ray sensor provided in an outside unit 210 detects a visitor close to a door 200, an image pickup apparatus 220 is turned on and indicates with character information via image display means 230 or with sound information via a speaker 240 that the visitor is close to the door and an picked-up image is recorded.

2. Disclosure of the Invention

However, in the conventional techniques, since the image pickup apparatus photographs a monitoring area without specifying who is approaching a house, there is a problem in that the crime prevention system unnecessarily operates even in a situation in which crime prevention is not necessary.

Specifically, in the conventional techniques, since the crime prevention system does not judge who is approaching the house, the crime prevention is actuated regardless of whether a person approaching the house is a resident of the house, a deliverer of newspaper or the like, or a neighbor.

For example, when a resident of the house comes home, it is less necessary to photograph the resident and prepare for crime prevention. Moreover, if the crime prevention system is operating when the resident comes home, the resident is required to cancel the crime prevention system or change setting of the crime prevention system to setting for the time when the resident is at home. The resident may feel this rather troublesome.

It cannot be said that it is very efficient as crime prevention to operate the crime prevention system even when a person less likely to illegally break into the house such as a deliverer of newspaper or the like or a neighbor approaches the door of the house. Moreover, in an apartment building such as a condominium, if the crime prevention system indicates with sound information using a speaker that photographing by the image pickup apparatus is performed as in the technique described in the Patent Document 2, a sound message is given every time a neighbor passes in front of the door. This rather causes a neighborhood nuisance.

The invention has been devised in view of the conventional problems and it is an object of the invention to provide a service providing apparatus, a service providing method, a service providing program, a computer-readable recording medium, and a key unit that makes it possible to perform more efficient crime prevention and can also be applied to provision of various services.

In order to attain the object, a service providing apparatus of the invention is characterized by including: an operation sensor that judges whether a user has operated an access point in an object of operation by the user; an access sensor that judges whether the user is present in a near area where the user could be present when the user operates the access point; and control means that controls an operation of the service providing apparatus, and in that the control means includes: ID authentication means that performs ID authentication for the user on the basis of results of the judgment of the access sensor and the operation sensor; and external processing determining means that causes an external apparatus to execute a service corresponding to a result of the ID authentication of the ID authentication means.

According to the constitution described above, when it is judged by the operation sensor that the user has operated the access point, it is possible to perform ID authentication for the user with the ID authentication means. It is possible to cause, with the external processing determining means, the external apparatus to perform external processing corresponding to a result of the ID authentication by the ID authentication means.

Consequently, for example, when the object of operation is an entrance door of a house and the access point is a door knob of the entrance, it is necessary to always operate the door knob when a person enters the house. Thus, it is possible to surely apply ID authentication to the person entering the house. It is possible to cause, according to a result of the ID authentication, an alarm apparatus or a report apparatus serving as the external apparatus provided in the house to execute crime prevention processing based on the ID authentication result as a service.

For example, when proper ID information could not be obtained by the ID authentication from the person who operated the door knob, it is possible to sound an alarm with the alarm apparatus or report to a predetermined report destination, with the report apparatus, that it is highly likely that illegal intrusion into the house is committed. On the other hand, when proper ID information could be obtained from the person who operated the door knob as a result of the ID authentication, it is possible to judge that a resident of the house has come home and execute, with the external processing determining means, a service for invalidating an operation of the alarm apparatus or the report apparatus serving as the external apparatus.

In this way, according to the invention, ID authentication is performed with operation of the operation object by the user as a trigger and external processing is executed by the external apparatus according to a result of the ID authentication. Therefore, in the invention, the external processing is not executed only because the user simply passes the front of the operation object. Thus, there is an advantage that it is possible to solve the trouble in that an alarm message is given only because a neighbor or the like passes in front of the door as in the past. When the resident comes home, it is also possible to automatically cancel the crime prevention system according to the invention. Thus, there is an advantage that it is also possible to solve a trouble for the resident in that the resident is required to cancel the crime prevention system every time the resident comes home as in the past.

Moreover, in the invention, the ID authentication means performs ID authentication for a user on the basis of a result of judgment of the access sensor. Thus, it is possible to perform ID authentication for the user when it is judged by the access sensor that the user is present around the operation object. Therefore, it is possible to prevent the ID authentication means from performing ID authentication, for example, when it is judged that the user is not present around the operation object. Therefore, it is possible to more efficiently perform ID authentication for the user and cause the external apparatus to execute a service.

In this way, according to the invention, it is possible to efficiently perform crime prevention against an illegal intruder. Moreover, according to the invention, as described later in the section of the mode for carrying out the invention, there are advantages that it is possible to execute various services corresponding to a user with operation of the operation object by the user as a trigger and it is also possible to increase satisfaction of the user when the user operates the operation object.

Other objects, characteristics, and excellences of the invention will be sufficiently understood according to the description below. Advantages of the invention will be apparent in the following explanations that refer to the accompanying drawings.

### BRIEF DESCRIPTION OF THE DRAWINGS

FIG. 1 is a block diagram showing a constitution of a security management apparatus according to an embodiment of a service providing apparatus of the invention.

FIG. 2 is a diagram schematically showing a crime prevention system that uses the security management apparatus in FIG. 1.

FIG. 3 is a block diagram showing a constitution of an ID authentication terminal used in the crime prevention system in FIG. 2.

FIG. 4 is a block diagram showing a constitution of a key unit that is an example of a preferred constitution of an ID authentication terminal.

FIG. 5 is a block diagram showing a constitution of a door knob sensor serving as a preferred constitution of an operation sensor in the security management apparatus in FIG. 1.

FIG. 6 is a flowchart showing a flow of processing that is executed by the security management apparatus in FIG. 1.

FIG. 7 is a flowchart showing a flow of processing that is executed by the security management apparatus in FIG. 1.

FIG. 8 is a diagram showing an example of a conventional crime prevention system.

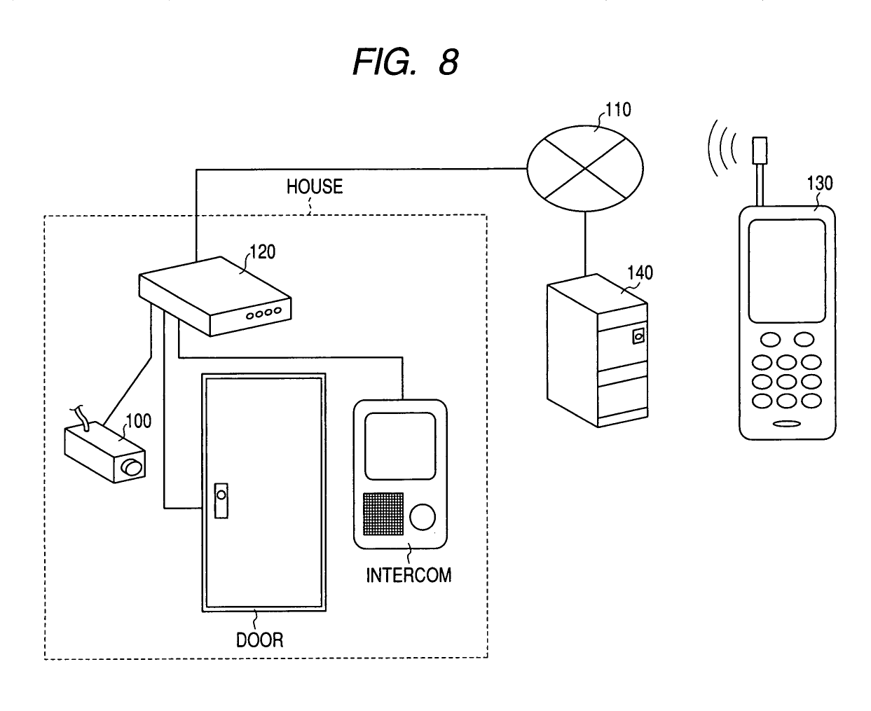

FIG. 9 is a diagram showing another example of the conventional crime prevention system.

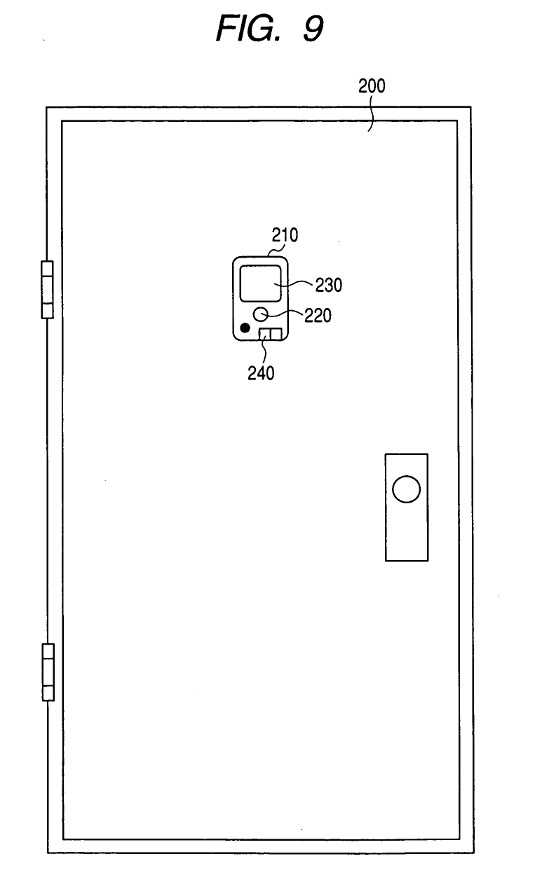

### BEST MODE FOR CARRYING OUT THE INVENTION

[1. Outline of a System]

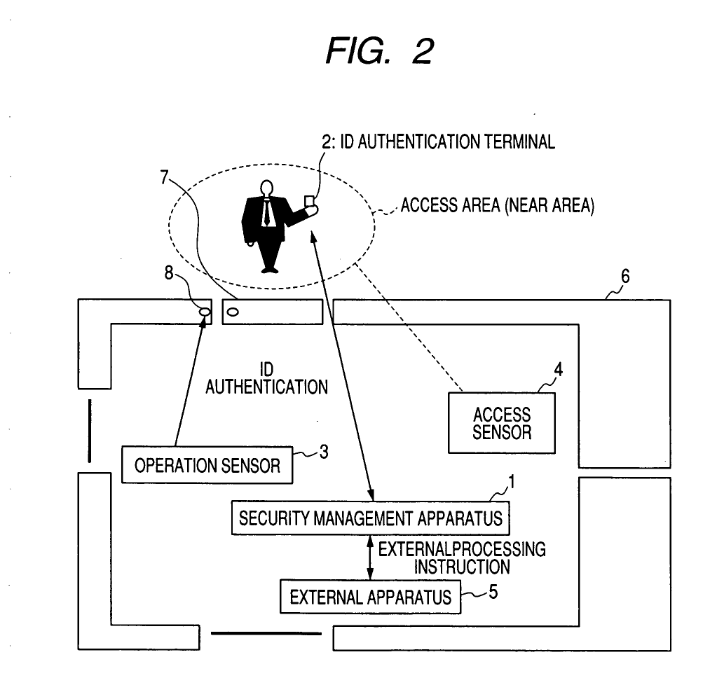

An outline of a crime prevention system that uses a security management apparatus, which is an embodiment of a service providing apparatus of the invention, will be explained using FIG. 2.

As shown in FIG. 2, the crime prevention system in this embodiment includes a security management apparatus 1, an ID authentication terminal 2, an operation sensor 3, an access sensor 4, and an external apparatus 5.

The security management apparatus 1 is set in a house 6 and performs short distance radio communication with the ID authentication terminal 2 carried by a user to thereby acquire ID information and attribute information of the user stored in the ID authentication terminal 2 and perform ID authentication. As the short distance radio communication, it is possible to use a communication system based on the radio LAN standard with a frequency of 2.4 GHz (gigahertz) or a communication system that uses a feeble radio wave in the Blue-Tooth (registered trademark) standard. Note that a constitution and a function of the security management apparatus 1 are described later.

As described above, the ID authentication terminal 2 records, as user information for authentication of a user of the ID authentication terminal 2 itself, ID information for specifying who the user is and attribute information indicating attributes of the user. It is preferable to use, as this ID authentication terminal 2, a medium that can be easily carried by the user and is capable of recording the user information, for example, an IC card, a cellular phone and the like.

It is possible to use, as the ID information, information on a name itself of the user or information obtained by encrypting the name of the user. It is possible to use, as the attribute information, information indicating sex, age, height, weight, physical condition, and the like of the user. Note that a constitution and a function of the ID authentication terminal 2 are described later.

The operation sensor 3 is a sensor for detecting whether the user has touched a door knob 8 (an access point) of an entrance door 7 with hand or whether the user has brought the hand to the door knob 8. It is possible to use, as the operation sensor 3, a vibration detecting sensor that detects vibration of the door knob 8 due to user operation, a touch sensor that detects a change in an electrostatic capacity, or the like. ID authentication by the security management apparatus 1 is executed with detection of user operation for the door knob 8 by this operation sensor 3 as a trigger.

The access sensor 4 is a sensor for detecting whether the user has approached an area where the user could be present when the user is operating the door knob 8 (an access area or a near area). It is possible to use, as the access sensor 4, a sensor that checks presence of a human body in an area within a radius of several meters, for example, a pyroelectric sensor, a microwave sensor, or an ultrasonic Doppler sensor.

The external apparatus 5 is an apparatus independent from the security management apparatus 1 such as an alarm apparatus, a report apparatus, an image display apparatus like a television, or an air conditioner in the house. The “external apparatus” also includes an apparatus such as an accounting apparatus, a PC terminal, or a cellular phone that is set outside the house.

With such a constitution, when it is detected by the operation sensor 3 that the user has touched the door knob 8, the security management apparatus 1 performs ID authentication using the ID authentication terminal 2 held by the user, gives an external processing instruction to the external apparatus 5 on the basis of a result of the ID authentication, and instructs the external apparatus 5 to execute various kinds of processing. Constitutions and functions will be hereinafter explained in detail concerning respective elements constituting the crime prevention system described above.

[2. Constitution of the ID Authentication Terminal]

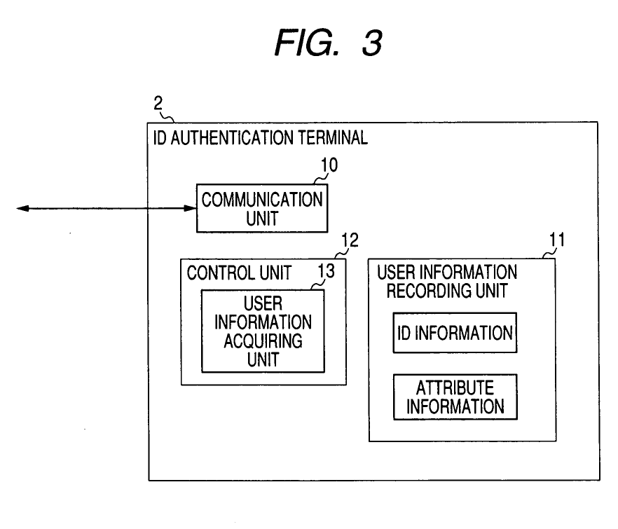

First, a constitution and a function of the ID authentication terminal 2 will be explained. As shown in FIG. 3, the ID authentication terminal 2 includes a communication unit 10, a user information recording unit 11, and a control unit 12.

The communication unit 10 is an interface circuit for performing communication with an external apparatus and realizes communication with the security management apparatus 1. For example, if the ID authentication terminal 2 is an IC card, the communication unit 10 is realized by an antenna coil that uses a part of energy emitted by the security management apparatus 1, which serves as a reader writer, as a power supply. If the ID authentication terminal 2 is a cellular phone, the communication unit 10 is realized by a communication circuit that realizes cellular phone communication in the cellular phone.

The user information recording unit 11 records the ID information and the attribute information as user information for authenticating a user of the ID authentication terminal 2. The ID information is information with which it is possible to specify who a user is. Thus, from the viewpoint of protection of privacy and prevention of illegal use, it is preferable to prevent the information from being changed after the information is once written in the user information recording unit 11. Therefore, it is preferable to constitute a part for recording the ID information of the user information recording unit 11 with a recording medium for which writing is possible only once such as a field programmable ROM and perform storage processing for the ID information when the ID authentication terminal 2 is started to be used for the first time.

Among the attribute information, the information indicating sex of the user basically does not change for the rest of the user's life but the information indicating age, height, weight, physical condition, and the like of the user changes from time to time. Thus, it is preferable that the attribute information is recorded in the ID authentication terminal 2 to be rewritable. Therefore, it is preferable that a part for recording the attribute information of the user information recording unit 11 is constituted by a rewritable recording medium, for example, an EEPROM (Electrically Erasable Programmable Read Only Memory).

The control unit 12 collectively controls processing in the ID authentication terminal 2. In particular, the control unit 12 includes a user information acquiring unit 13 that acquires the ID information or the attribute information from the user information recording unit 11. Note that the acquisition of the user information by the user information acquiring unit 13 is executed on the basis of a user information acquisition request via the communication unit 10 from the security management apparatus 1. The user information acquired is transmitted to the security management apparatus 1 by the communication unit 10.

With the constitution described above, the ID authentication terminal 2 performs communication with the security management apparatus 1 using the communication unit 10 and reads out the ID information or the attribute information recorded in the user information recording unit 11 using the user information acquiring unit 13 on the basis of a content of the communication. Moreover, the ID authentication terminal 2 transmits the ID information or the attribute information to the security management apparatus 1 using the communication unit 10.

[3. Constitution of the Security Management Apparatus]

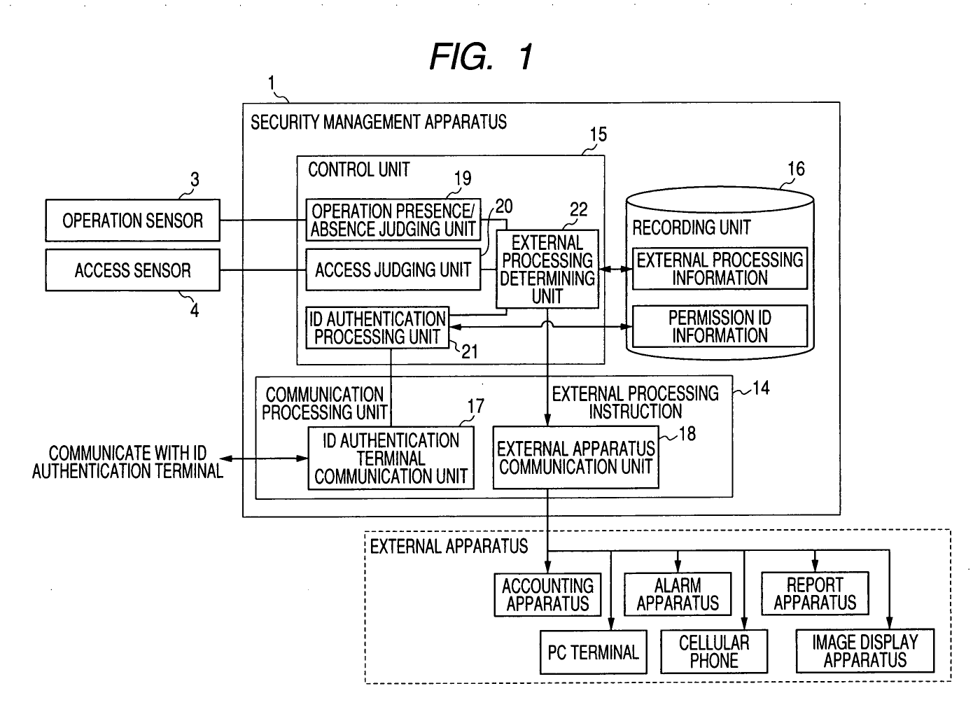

A constitution and a function of the security management apparatus 1 will be explained. As shown in FIG. 1, the security management apparatus 1 includes a communication processing unit (radio communication means) 14, a control unit (control means) 15, and a recording unit 16.

The communication processing unit 14 is an interface circuit for performing communication with an external apparatus and includes an ID authentication terminal communication unit (radio communication means) 17 that realizes communication with the ID authentication terminal 2 and an external apparatus communication unit (radio communication means) 18 that realizes communication with the external apparatus.

Communication between the ID authentication terminal communication unit 17 and the security management apparatus 1 is realized by short distance radio communication as described above. Thus, the ID authentication terminal communication unit 17 only has to realize short distance radio communication in about several meters.

On the other hand, the external apparatus communication unit 18 may adopt wire communication using an ordinary cable or may adopt radio communication in a short distance. In particular, when the external apparatus is an apparatus such as a PC terminal or a cellular phone set outside the house, it is preferable that the external apparatus communication unit realizes wide area communication such as the Internet or the cellular phone network.

Note that, although the ID authentication terminal communication unit 17 and the external apparatus communication unit 18 are shown as separate blocks in FIG. 1, these communication units do not always have to be constituted as separate units. It is also possible to cause radio communication means, which is capable of switching width of a communication area by switching output of a radio wave used for communication, to carry out the roles of the ID authentication terminal communication unit 17 and the external apparatus communication unit 18.

In other words, if narrow area radio communication in an area within a radius of several meters is realized by outputting a radio wave of low power with the radio communication means described above, it is possible to cause the radio communication means to bear the function of the ID authentication terminal communication unit 17. On the other hand, if wide area communication in an area within a radius of several kilometers is realized by outputting a radio wave of high power with the radio communication means, it is also possible to cause the radio communication means to bear the role of the external apparatus communication unit 18.

The control unit 15 collectively controls processing inside the security management apparatus 1. In particular, the control unit 15 includes an operation presence/absence judging unit 19, an access judging unit 20, an ID authentication processing unit (ID authentication means) 21, and an external processing determining unit (external processing determining means) 22.

The operation presence/absence judging unit 19 judges whether operation of the door knob 8 by a user is detected by the operation sensor 3. The access judging unit 20 judges whether presence of a human near the door knob 8 is detected by the access sensor 4.

The ID authentication processing unit 21 executes ID authentication processing by performing communication with the ID authentication terminal 2 via the communication processing unit 14. Specifically, the ID authentication processing unit 21 acquires ID information stored in the user information recording unit 11 of the ID authentication terminal 2 and performs ID authentication processing by comparing the ID information and permission ID information recorded in the recording unit 16 of the security management apparatus 1.

The permission ID information recorded in the recording unit 16 of the security management apparatus 1 is information indicating an ID of a person who is permitted to be present in the house such as a resident, a friend of the resident, a relative of the resident, or the like. Therefore, the ID authentication processing unit 21 can judge whether the ID authentication terminal 2 has proper ID information by judging whether the ID information acquired via the ID authentication terminal communication unit 17 is included in the permission ID information.

Note that ID authentication processing for the user is not limited to the system for acquiring ID information in the ID authentication terminal 2 to perform authentication processing as described above. For example, it is also possible to provide biometric means, that is, means for finger print recognition, face recognition, retina recognition, iris recognition, or voice recognition in the security management apparatus 1 and perform authentication of the user using the biometric means.

The external processing determining unit 22 gives an external processing instruction to an external apparatus via the external apparatus communication unit 18 on the basis of a result of judgment by the operation presence/absence judging unit 19, a result of judgment by the access judging unit 20, and a result of ID authentication by the ID authentication processing unit 21. Specifically, the external processing determining unit 22 judges, with the operation presence/absence judging unit 19, that the user has operated the door knob 8. When it is judged by the access judging unit 20 that a human is present near the door knob 8, the external processing determining unit 22 gives an operation instruction to the external apparatus to execute processing corresponding to the ID information and the attribute information obtained by the ID authentication processing unit 21. Details of operations performed by the external apparatus are described later.

As described above, the security management apparatus 1 acquires the ID information and the attribute information of the user from the ID authentication terminal 2 carried by the user and performs the ID authentication processing with the ID authentication processing unit 21. In addition, the security management apparatus 1 determines processing performed by the external apparatus taking into accounts results of judgment of the operation presence/absence judging unit 19 and the access judging unit 20.

[4. Preferred Constitution of the ID Authentication Terminal]

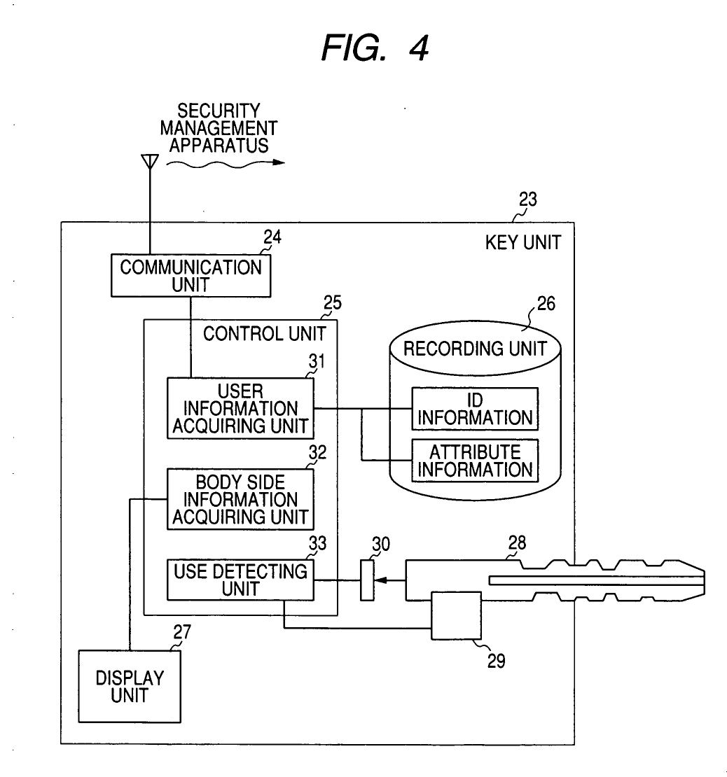

A constitution of a key unit that is a preferred embodiment of the ID authentication terminal will be explained. As shown in FIG. 4, the key unit 23 in this embodiment includes a communication unit (ID information transmitting means) 24, a control unit 25, a recording unit (recording means) 26, and a display unit (display means) 27. Moreover, the key unit 23 includes a key section (a key portion) 28 that is inserted into a keyhole, a torque sensor (an operation sensor) 29 that detects torque generated in the key section 28 when the key section 28 is inserted into the keyhole to unlock or lock the door, and a pressure sensor (an operation sensor) 30 that detects a force applied to the key unit by the key section when the key section 28 is inserted into the keyhole.

The communication unit 24 is an interface circuit for performing communication between the key unit 23 and the external apparatus. In particular, since the communication unit 24 realizes communication with the security management apparatus 1, it is preferable to adopt the short distance radio communication system.

The control unit 25 collectively controls processing inside the key unit. In particular, the control unit 25 includes a user information acquiring unit 31, a body side information acquiring unit 32, and a use detecting unit 33.

The user information acquiring unit 31 acquires the ID information and the attribute information recorded in the recording unit 26. Moreover, the user information acquiring unit 31 transmits the ID information and the attribute information acquired from the recording unit 26 to the ID authentication processing unit 21 of the security management apparatus 1 such that the ID authentication processing unit 21 of the security management apparatus 1 can use the information for ID authentication.

The body side information acquiring unit 32 acquires abnormality history information indicating an abnormality history in the house in the past, resident information indicating a person currently present in the house, and the like from the recording unit 16 of the security management apparatus 1 via the communication unit 24.

The abnormality history information is created by the control unit 15 of the security management apparatus 1. Specifically, when the ID authentication processing unit 21 cannot acquire proper ID information from the user operating the door knob 8, information indicating time when it is highly likely that illegal intrusion into the house was committed is created as the abnormality history information.

The resident information is also created by the control unit 15 of the security management apparatus 1. Specifically, when proper ID information could be acquired from the user operating the door knob 8, the control unit 15 creates a history of the acquisition of the ID information as the resident information.

The display unit 27 is constituted by an image display device such as a liquid crystal panel and displays the abnormality history information and the resident information acquired by the body side information acquiring unit 32. Since the information is displayed on the display unit 27, the user can check an abnormality history in the past in the house and a person currently present in the house.

The use detecting unit 33 judges whether the key section 28 of the key unit 23 is currently inserted into the keyhole and used for unlocking or locking the door by judging an output of the torque sensor 29 or the pressure sensor 30.

When the user inserts the key section 28 of the key unit 23 into the keyhole to unlock the door, since the key section 28 rotates the keyhole, torque is generated in the key section 28. Therefore, it is possible to judge whether the key unit 23 is used by the torque sensor 29. When the user inserts the key unit 23 into the keyhole, since a force for pressing the key section 28 against the keyhole is generated, if a reaction to the force is detected by the pressure sensor 30, it is possible to judge whether the key unit 23 is used.

This use detecting unit 33 functions as the operation sensor 3 described above. When the user inserts the key section 28 of the key unit 23 into the keyhole, the user simultaneously brings the hand close to the door knob. Therefore, if it is judged by the use detecting unit 33 whether the key unit 23 is used, it is possible to judge whether the user has brought the hand close to the door knob 8.

In this way, since the use detecting unit 33 is provided in the key unit 23, the key unit 23 has a function as the ID authentication terminal 2 and a function as the operation sensor 3. In other words, in the key unit 23 in this embodiment, since the ID authentication terminal 2 and the operation sensor 3 are integrally constituted, in particular, it is unnecessary to provide the operation sensor 3 in the door knob 8. Therefore, it is possible to provide the crime prevention system in this embodiment at lower cost.

[5. Door Knob Sensor]

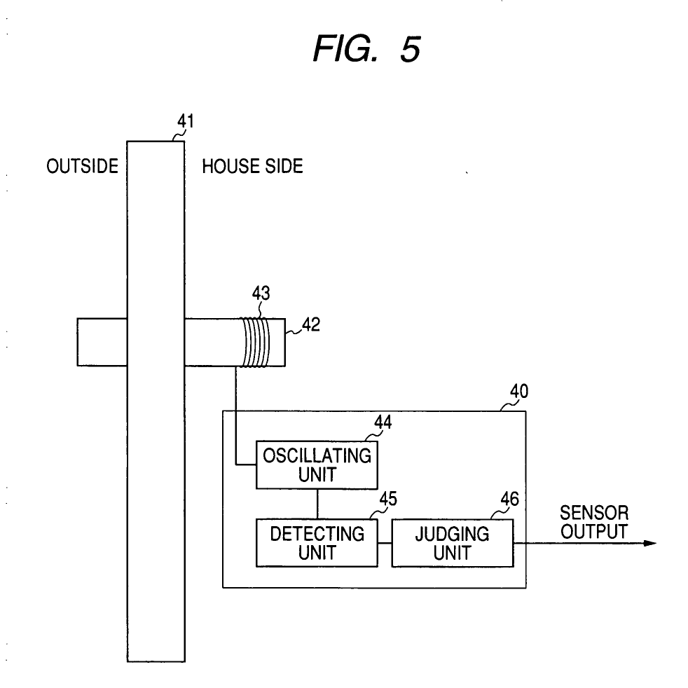

A constitution of a door knob sensor that is a preferred embodiment of the operation sensor will be explained. As shown in FIG. 5, a door knob sensor 40 in this embodiment includes a coil 43 attached to a door knob 42 of a door 41, an oscillating unit (magnetic field generating means) 44, a detecting unit (detecting means) 45, and a judging unit 46.

The oscillating unit 44 generates an induction field by giving an electric current to the coil 43 attached to the door knob 42. A magnetic force of the induction field generated by the oscillating unit 44 changes when a user brings the hand close to the door knob 42. The detecting unit 45 detects a change in the magnetic force generated in this way.

The judging unit 46 judges whether the user has brought the hand close to the door knob by judging whether the detecting unit 45 has detected a magnetic force change equal to or higher than a predetermined level. As the user brings the hand closer to the door knob, a larger change occurs in a magnetic field generated by the coil 43. Therefore, the judging unit 46 judges that the user has brought the hand close to the door knob when the detecting unit 45 has detected a magnetic force change equal to or higher than the predetermined level.

In this way, according to the door knob sensor 40 in this embodiment, it is possible to judge whether the user has brought the hand close to the door knob with a simple constitution in which the coil 43 is attached to the door knob 42. Therefore, it is possible to provide the operation sensor 3 in the door without opening a hole in the door to provide a vibration detecting sensor or a touch sensor. Thus, it is possible provide the crime prevention system in this embodiment at low cost.

[6. Processing Flow]

A processing flow executed by the security management apparatus 1 in this embodiment will be explained. Note that the processing flow executed by the security management apparatus 1 includes two types of processing flows at the time when a result of detection of the access sensor 4 is used and at the time when a result of detection of the access sensor 4 is not used. Thus, these processing flows will be explained in order.

(6-1. When a Result of Detection of the Access Sensor is not Used)

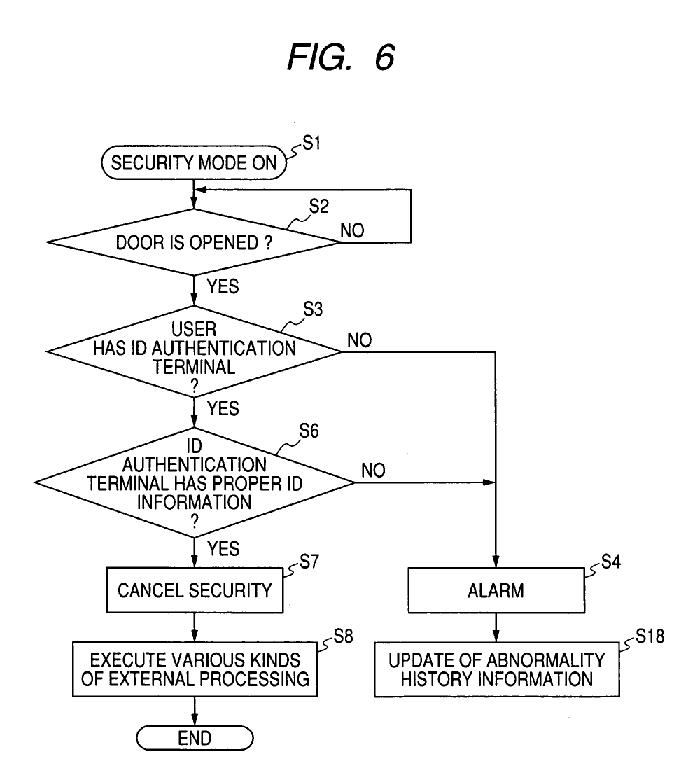

First, the processing flow at the time when a result of detection of the access sensor is not used will be explained. As shown in FIG. 6, a security mode is set to ON by the control unit 25 of the security management apparatus 1 (step 1; each step is simply described as “S” in the following description) Note that the security mode means a mode for canceling security and executing external processing on the basis of the ID information recorded in the ID authentication terminal 2 as described later.

Thereafter, it is detected by the operation sensor 3 whether the entrance door 7 is opened (S2). When it is judged in S2 that the entrance door is not opened, the processing returns to S2 and it is judged whether the entrance door is opened.

When it is judged in S2 that the entrance door 7 is opened, it is judged by the ID authentication terminal communication unit 17 whether a user has the ID authentication terminal 2 (S3). Specifically, the ID authentication terminal communication unit 17 judges whether the ID authentication terminal 2 is present within a communication area in which communication is possible, whereby the judgment in S2 is performed.

When it is judged in S3 that the user does not have the ID authentication terminal, since a person not having the ID authentication terminal has opened the entrance door 7, it is highly likely that illegal intrusion into the house is committed. Thus, the external processing determining unit 22 instructs, on the basis of a result of the judgment, an alarm apparatus serving as an external apparatus to perform processing for sounding an alarm as external processing (S4).

In S4, the external processing determining unit 22 may instructs a report apparatus serving as the external apparatus to perform processing for reporting to a predetermined report destination that illegal intrusion is about to be committed as external processing. In particular, in reporting that illegal intrusion is about to be performed, it is advantageous to cause the radio communication means capable of switching width of a communication area to bear the roles of the ID authentication terminal communication unit 17 and the external apparatus communication unit 18.

If radio communication in a wide area is performed by the radio communication means, it is possible to also report to the ID authentication terminal of the user in a location several kilometers away that illegal intrusion is about to be committed. Consequently, it is possible to inform the user of illegal intrusion into the house promptly.

After S4, in S5, the control unit 15 updates the abnormality history information in the recording unit 16. Specifically, the control unit 15 adds the fact that the person not having the ID authentication terminal opened the entrance door and time when the entrance door is opened by the person to the abnormality history information. This abnormality history information is effectively utilized when the user carries the key unit 23 described above.

When the user carries the key unit 23 (see FIG. 4), since the abnormality history information is displayed on the display unit 27, before entering the house, the user can check whether illegal intrusion into the house was committed. Therefore, it is possible to prevent an accident in which a resident bumps into an illegal intruder and the illegal intruder uses violence on the resident.

On the other hand, when it is judged in S3 that the user has the ID authentication terminal, it is judged by the ID authentication processing unit 21 whether the ID authentication terminal has proper ID information (S6). In S6, for example, as described above, the ID authentication processing unit 21 can judge whether the ID authentication terminal has proper ID information by judging whether ID information acquired by the ID authentication terminal communication unit 17 is included in the permission ID information.

When it is judged in S6 that the ID authentication terminal does not have proper ID information, after the alarm sounding processing in S4 is executed, update processing for the abnormality history information is executed in S5.

When it is judged in S6 that the ID authentication terminal has proper ID information, security cancellation processing is executed by the control unit 15. The security cancellation processing means processing for stopping operations of a vibration sensor for illegal intrusion detection attached to a window or a door in the house and a crime prevention sensor such as a human body detecting sensor or the like attached in the house.

After the security cancellation processing is performed in S7, in S8, the external processing determining unit 22 gives an external processing instruction to the external apparatus to execute various kinds of processing corresponding to the ID information of the ID authentication terminal 2.

For example, when the ID information of the ID authentication terminal is ID information of a child, the external processing determining unit 22 gives an external processing instruction to start the crime prevention sensor serving as the external apparatus or lock keys serving as the external apparatus attached to an entrance, doors, windows, and the like of the house. This makes it possible to prevent damage due to violence used by the illegal intruder into the house on the child. When the ID information of the ID authentication terminal is ID information of an old person, the same external processing instruction is given by the external processing determining unit 22.

When a room is allocated to each of individuals in the house, it is also possible that a room allocated to the individual is judged from the ID information of the ID authentication terminal and an external processing instruction is given by the external processing determining unit 22 to turn on a light in the room serving as the external apparatus. Moreover, an external processing instruction may be given from the external processing determining unit 22 such that an air conditioner in the room serving as the external apparatus operates.

(6-2. When a Result of Detection of the Access Sensor is Used)

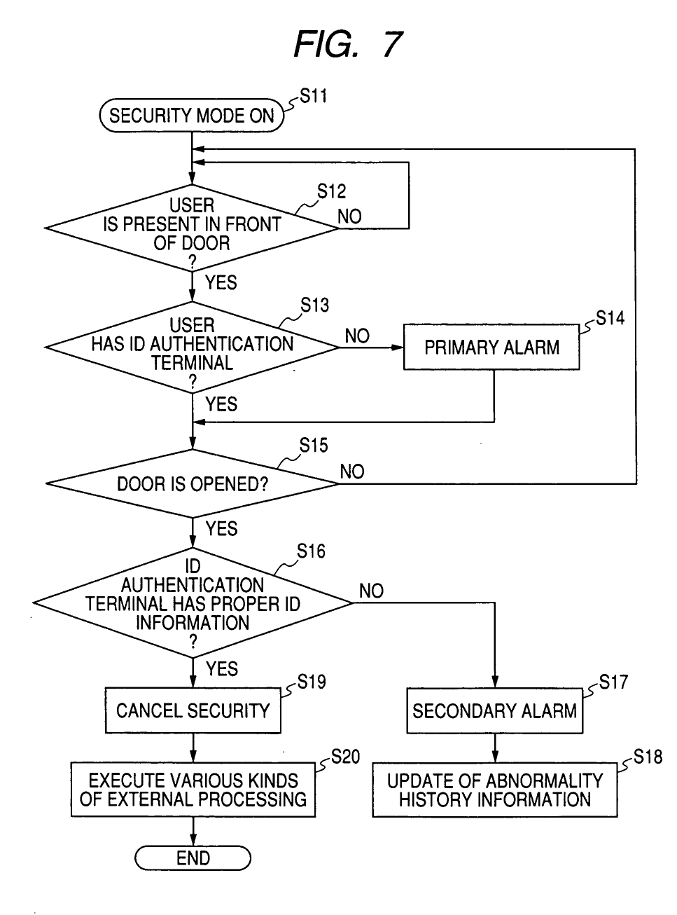

A processing flow at the time when a result of detection of the access sensor is used will be explained. As shown in FIG. 7, a security mode is set to ON by the control unit 25 of the security management apparatus 1 (S11).

Thereafter, it is judged by the access sensor 4 whether the user is present in front of the entrance door 7 (S12). When it is judged in S12 that the user is not present in front of the entrance door 7, it is judges in S12 again whether the user is present in front of the entrance door 7.

When it is judged in S12 that the user is present in front of the door, it is judged by the ID authentication terminal communication unit 17 whether the user has the ID authentication terminal 2 (S13). When it is judged in S13 that the user does not have the ID authentication terminal 2, the external processing determining unit 22 instructs the alarm apparatus serving as the external apparatus to perform primary alarm processing (S14).

The primary alarm processing means processing for informing, by sounding the alarm with the alarm apparatus, the user that it is likely that illegal intrusion into the house is about to be committed. When it is judged in S13 that the user present in front of the entrance door does not have the ID authentication terminal 2, this means that a person other than residents of the house is standing in front of the entrance door. Thus, it can be judged that it is highly likely that illegal intrusion into the house is about to be committed.

However, when a deliverer of newspaper or mail is standing in front of the entrance door, if an alarm of large volume is sounded, a neighborhood nuisance may be caused. Therefore, in the primary alarm processing, it is preferable to sound an alarm of relatively small volume. When the ID authentication terminal of the user is not recognized in S13 until a predetermined time passes after it is judged in S12 that the user is present in front of the door, the primary alarm processing may be executed in S14.

On the other hand, when it is judged in S13 that the user has the ID authentication terminal, in S15, it is judged by the operation sensor 3 whether the user has opened the entrance door 7 (S15). When it is judged in S15 that the user has not opened the door, it is judged again in S12 whether the user is present in front of the entrance door.

On the other hand, when it is judged in S15 that the user has opened the entrance door, in S16, it is judged by the ID authentication processing unit 21 whether the ID authentication terminal has proper ID information. Since processing in S16 is the same as that in S6 in FIG. 6, a detailed explanation of the processing is omitted.

When it is judged in S16 that the ID authentication terminal does not have proper ID information, in S17, the external processing determining unit 22 instructs the alarm apparatus serving as the external apparatus to perform secondary alarm processing (S17).

The secondary alarm processing in S17 is the same processing as S4 in FIG. 6. The secondary alarm processing means processing in which the alarm apparatus serving as the external apparatus sounds an alarm or processing in which the report apparatus reports to a predetermined report destination that illegal intrusion is about to be committed.

When this secondary alarm processing is performed, the user not having the proper ID authentication terminal has already entered the house, it is extremely highly likely that illegal intrusion into the house is committed. Therefore, in the secondary alarm processing, it is possible to effectively threaten the illegal intruder by performing processing for sounding an alarm more loudly or for reporting illegal intrusion to the predetermined report destination.

Moreover, after S17, in S18, the control unit 15 updates the abnormality history information in the recording unit 16. Since processing in S18 is the same as the processing in S5 in FIG. 6, a detailed explanation of the processing is omitted.

On the other hand, when it is judged in S16 that the ID authentication terminal has proper ID information, in S19, security cancellation processing is executed by the control unit 15. Then, in S20, an instruction for executing various kinds of processing corresponding to the ID information in the ID authentication terminal 2 is given to the external apparatus by the external processing determining unit 22. Since processing in S19 is identical with the processing in S7 in FIG. 6 and processing in S20 is identical with the processing in S8 in FIG. 6, a detailed explanation of the processing is omitted.

### 7. EXAMPLES OF APPLICATION TO OTHER SERVICES

In the embodiments described above, the door knob of the entrance door is set as the access point and, when the user operates the access point, that is, when the user accesses the access point, ID authentication for the user is performed and the external processing is performed on the basis of a result of the ID authentication. However, a range of application of the service providing apparatus of the invention is not limited to only the crime prevention system described above.

For example, it is possible to use the service providing apparatus of the invention for an operation explanation system for a machine tool. When an operation unit of the machine tool is an access point, if a user accesses the access point, it is possible to perform ID authentication for the user and perform external processing corresponding to an ID of the user by using the service providing apparatus of the invention.

Specifically, the operation sensor described above is provided in the operation unit of the machine tool and, when it is judged by the operation sensor that the user has operated the operation unit, the ID authentication for the user is performed. It is possible to judge how proficient the user is about operation of the machine tool from ID information of the user and execute an operation explanation corresponding to the proficiency with processing performed from a display of the machine tool as external processing. For example, for a beginner, it is possible to explain operation of the machine tool by performing processing for displaying an operation method on the display of the machine tool in detail and performing operation guidance by sounds. On the other hand, for a skilled worker, it is also possible to perform processing for not performing an operation explanation at all.

It is also possible to use the service providing apparatus of the invention for a PC (Personal Computer). When a section to which a user always accesses in operating the PC, for example, a power switch, a mouse, or a keyboard is an access point, it is possible to perform external processing described below by using the service providing apparatus of the invention.

Specifically, an operation sensor is provided in the power switch of the PC and, when it is judged by the operation sensor that a user has depressed the power switch, ID authentication for the user is performed. It is possible to perform processing for displaying a start screen set for each user as external processing on the basis of ID information of the user obtained by the ID authentication. Moreover, when each user makes different setting for a program executed at the start of the PC, it is possible to perform, as external processing, processing for automatically executing the program set by the user on the basis of ID information of the user obtained by the ID authentication.

It is also possible to use the service providing apparatus of the invention for a cooking provision service. When a section to which a user always access in cooking, for example, an open/close handle of a refrigerator is an access point, it is possible to perform external processing described below by using the service providing apparatus of the invention.

Specifically, an operation sensor is provided in the open/close handle of the refrigerator and, when it is judged by the operation sensor that a user has operated the open/close handle, ID authentication for the user is performed. It is possible to perform, as external processing, processing for judging a physical condition of the user from ID information of the user, selecting food materials optimum for the physical condition of the user, and displaying the food materials on a display of the refrigerator.

It is also possible to use the service providing system of the invention for an accounting system in using a rent-a-car. When a section to which a user always accesses in using a rent-a-car, for example, a door handle or a steering wheel is an access point, it is possible to perform external processing described below by using the service providing apparatus of the invention.

Specifically, an operation sensor is provided in the access point and, when it is judged by the operation sensor that a user has operated the door handle or the like, ID authentication for the user is performed. It is possible to transmit ID information obtained by the ID authentication to a management server that manages a rent-a-car use charge and automatically charge a user charge for each user.

[8. Supplement]

The respective blocks of the security management apparatus 1 may be constituted by a hardware logic or may be realized by software using a CPU as described below.

The security management apparatus 1 includes a CPU (central processing unit) that executes instructions of a control program for realizing the respective functions, a ROM (read only memory) having stored therein the program, a RAM (random access memory) that expands the program, and a storage (a recording medium) such as a memory in which the program and various data are stored. It is also possible to attain the object of the invention when a recording medium having recorded therein program codes (an execution format program, an intermediate code program, and a source program) of a control program of the security management apparatus 1, which is software for realizing the functions, so as to be readable by a computer is supplied to the security management apparatus 1 and the computer (or a CPU or an MPU) reads out and executes the program codes recorded in the recording medium.

As the recording medium, for example, it is possible to use a tape recording medium such as a magnetic tape or a cassette tape, a disk recording medium including a magnetic disk such as a floppy (registered trademark) disk or a hard disk and an optical disk such as a CD-ROM, an MO, an MD, a DVD, or a CD-R, a card recording medium such as an IC card (including a memory card) or an optical card, or a semiconductor memory recording medium such as a mask ROM, an EPROM, an EEPROM, or a flash ROM.

The security management apparatus 1 may be constituted to be connectable to a communication network to supply the program codes via the communication network. The communication network is not specifically limited. It is possible to use, for example, the Internet, an Intranet, an Extranet, a LAN, an ISDN, a VAN, a CATV communication network, a virtual private network, a telephone line network, a mobile communication network, and a satellite communication network. A transmission medium constituting the communication network is not specifically limited. It is possible to use either a wire transmission medium such as IEEE1394, USB, power-line carrier, a cable TV line, a telephone line, and an ADSL line or a radio transmission medium such as infrared rays including IrDA and a remote controller, Bluetooth, 802.11 radio, HDR, a cellular phone network, a satellite line, and a ground wave digital network. Note that the invention can be realized in a form of a carrier wave or a data signal string in which the program codes are embodied in electronic transmission.

As described above, the service providing apparatus of the invention includes: an operation sensor that judges whether a user has operated an access point in an object of operation by the user; an access sensor that judges whether the user is present in a near area where the user could be present when the user operates the access point; and control means that controls an operation of the service providing apparatus. The control means includes ID authentication means that performs ID authentication for the user on the basis of results of the judgment of the access sensor and the operation sensor; and external processing determining means that causes an external apparatus to execute a service corresponding to a result of the ID authentication of the ID authentication means.

According to the constitution described above, when it is judged by the operation sensor that the user has operated the access point, it is possible to perform ID authentication for the user with the ID authentication means. It is possible to cause, with the external processing determining means, the external apparatus to perform external processing corresponding to a result of the ID authentication by the ID authentication means.

Consequently, for example, when the object of operation is an entrance door of a house and the access point is a door knob of the entrance, it is necessary to always operate the door knob when a person enters the house. Thus, it is possible to surely apply ID authentication to the person entering the house. It is possible to cause, according to a result of the ID authentication, an alarm apparatus or a report apparatus serving as the external apparatus provided in the house to execute crime prevention processing based on the ID authentication result as a service.

For example, when proper ID information could not be obtained by the ID authentication from the person who operated the door knob, it is possible to sound an alarm with the alarm apparatus or report to a predetermined report destination, with the report apparatus, that it is highly likely that illegal intrusion into the house is committed. On the other hand, when proper ID information could be obtained from the person who operated the door knob as a result of the ID authentication, it is possible to judge that a resident of the house has come home and execute, with the external processing determining means, a service for invalidating an operation of the alarm apparatus or the report apparatus serving as the external apparatus.

In this way, according to the invention, ID authentication is performed with operation of the operation object by the user as a trigger and external processing is executed by the external apparatus according to a result of the ID authentication. Therefore, in the invention, the external processing is not executed only because the user simply passes the front of the operation object. Thus, there is an advantage that it is possible to solve the trouble that an alarm message is given only because a neighbor or the like passes in front of the door as in the past. When the resident comes home, it is also possible to automatically cancel the crime prevention system according to the invention. Thus, there is an advantage that it is also possible to solve a trouble for the resident that the resident is required to cancel the crime prevention system every time the resident comes home as in the past.

Moreover, in the invention, the ID authentication means performs ID authentication for a user on the basis of a result of judgment of the access sensor. Thus, it is possible to perform ID authentication for the user when it is judged by the access sensor that the user is present around the operation object. Therefore, it is possible to prevent the ID authentication means from performing ID authentication, for example, when it is judged that the user is not present around the operation object. Therefore, it is possible to more efficiently perform ID authentication for the user and cause the external apparatus to execute a service.

In this way, according to the invention, it is possible to efficiently perform crime prevention against an illegal intruder. Moreover, according to the invention, as described later in the section of the mode for carrying out the invention, there are advantages that it is possible to execute various services corresponding to a user with operation of the operation object by the user as a trigger and it is also possible to increase satisfaction of the user when the user operates the operation object.

Moreover, in the service providing apparatus of the constitution described above, when the object of operation by the user is a door for entering the house and the access point is a door knob of the door and, on the other hand, the operation sensor is constituted to detect an operation of a key, which is used for unlocking the door, unlocking the door, the following advantages are realized.

When a resident tries to enter the house, it is necessary to insert the key in the keyhole of the locked door to unlock the door and, then, operate the door knob. According to the constitution, since the operation sensor detects an operation of the key unlocking the door, it is possible to accurately detect that the user has unlocked the door using the key. Therefore, it is also possible to accurately detect that the user operates the door knob.

Consequently, ID authentication processing by the ID authentication means and service execution processing of the external apparatus by the external processing determining means are surely performed in association with door knob operation by the user. Thus, there is an advantage that it is possible to perform more efficient crime prevention.

Note that it is possible to easily realize the operation sensor that detects an operation of the key unlocking the door with, for example, a pressure sensor that detects a force generated in a direction of a key when the key is inserted into a keyhole of a door or a torque sensor that detects a torque generated in a key used for unlocking the door when the key is inserted into the keyhole and rotated.

The following advantage is realized by constituting the operation sensor to include a coil provided in the door knob, magnetic field generating means that generates an induction field with the coil, and detecting means that detects a magnetic force change in the induction field generated by the magnetic field generating means.

According to the constitution, it is possible to generate an induction field around the door knob with the coil and the magnetic field generating means. When a user brings the hand close to the door knob in an attempt to operate the door knob, a magnetic force change occurs in the induction field generated around the door knob. However, it is possible to detect the magnetic force change with the detecting means.

In this way, according to the operation sensor with the constitution, it is possible to accurately detect operation of the door knob by the user. Therefore, ID authentication processing by the ID authentication means and service execution processing of the external apparatus by the external processing determining means are surely performed in association with door knob operation by the user. Thus, there is an advantage that it is possible to perform more efficient crime prevention.

Moreover, in the service providing apparatus with the constitution, radio communication means that is capable of switching width of an area, in which communication is possible, by switching an output of a radio wave used for communication is provided. The ID authentication means is constituted to perform ID authentication for the user by judging whether ID information acquired from an ID authentication terminal carried by a user by performing narrow area radio communication using the ID authentication terminal and the radio communication means is included in permission ID information recorded in the service providing apparatus and, on the other hand, when it is impossible to acquire proper ID information via the radio communication means, transmit information indicating that it is impossible to acquire proper ID information to the external apparatus by performing wide area radio communication using the radio communication means. Consequently, the following advantage is realized.

According to the constitution, there is an advantage that it is possible to perform user authentication by simple processing of performing narrow area radio communication with the radio communication means to acquire ID information of the user from the ID authentication terminal of the user and judging whether the information is included the permission ID information recorded in the service providing apparatus. The permission ID information means information in which an ID of a user permitted to operate an operation object is stored. The narrow area radio communication is used to means radio communication within a radius of several meters.

When it is impossible to acquire proper ID information from the ID authentication terminal, wide area radio communication is performed by the radio communication means to transmit information indicating that it is impossible to acquire proper ID information to the external apparatus. Thus, it is possible to inform the external apparatus that a person not permitted to operate the operation object attempts to illegally operates the operation object. Consequently, in the external apparatus, it is possible to execute predetermined processing at the time when illegal operation is attempted, for example, report processing for reporting to the outside or sounding processing of an alarm. Note that the wide area radio communication is used to mean radio communication within a radius of several kilometers.

In this way, according to the invention, it is possible to perform the ID authentication processing and the processing for informing the external apparatus of illegal operation of the operation object by switching width of the area, in which communication is possible, with the radio communication means. Therefore, there is an advantage that it is possible to further simplify the constitution of the service providing apparatus and improve convenience for the user.

The service providing method of the invention includes: a first step of judging, with an operation sensor of a service providing apparatus, whether a user has operated an access point in an object of operation by the user; a second step of performing, with ID authentication means of the service providing apparatus, ID authentication for the user based on a result of the judgment of the operation sensor; and a third step of causing, with external processing determining means of the service providing apparatus, an external apparatus to execute a service corresponding to a result of the ID authentication of the ID authentication means.

In the service providing method, in the respective step from the first step to the third step, processing identical with the processing in the service providing apparatus of the invention is realized. Thus, it is possible to obtain actions and advantages same as those in the service providing apparatus of the invention.

As described above, the key unit of the invention includes: a key section that is inserted into a keyhole of a door; recording medium that records ID information of a user; an operation sensor that detects that the key section is inserted into the keyhole of the door; and ID information transmitting means that transmits the ID information of the user from the recording means to ID authentication means on the outside that performs ID authentication for the user based on the result of detection by the operation sensor. Thus, the key unit realizes the following advantage.

According to the constitution, when the user inserts the key section in order to unlock the door, it is detected by the operation sensor that the key section is inserted into the keyhole. The ID information of the user is transmitted from the recording means by the ID information transmitting means.

By providing the ID authentication means in the service providing apparatus of the invention, in a series of operations for the user to unlock the door, the ID information is automatically transmitted from the key unit to the ID authentication means and the ID authentication is performed. Therefore, the user can cause the service providing apparatus to execute the ID authentication without performing unnecessary operations other than unlocking the door. Thus, there is an advantage that it is possible to provide a key unit suitable for use in the service providing apparatus of the invention.

The key unit with the constitution includes display means that acquires, from the ID authentication means, at least one of abnormality history information indicating time when it is highly likely that illegal intrusion into a house was committed and resident information indicating a person present in the house, which are created on the basis of a result of the ID authentication performed by the ID authentication means, and displays the abnormality history information or the resident information. Consequently, the following advantage is realized.

According to the constitution, the user can learn likelihood of illegal intrusion into the house or a person currently present in the house by checking the abnormality history information or the resident information displayed on the display means of the key unit. Note that the abnormality history information is created by, when the ID authentication means could not acquire proper ID information from the recording means of the key unit, recording a history of the unavailability of proper ID information. The resident information is created by, when the ID authentication means acquires proper ID information from the recording means of the key unit, recording a history of the acquisition of proper ID information.

Therefore, the user can judge what kind of person is currently present in the house before entering the house. Thus, there is an advantage that it is possible to prevent an accident in which a resident bumps into an illegal intruder and the illegal intruder uses violence on the resident.

The service providing program of the invention causes a computer to function as the control means in the service providing apparatus in the constitution described above. The computer-readable recording medium of the invention stores the service providing program. Consequently, it is possible to cause an arbitrary computer to execute the service providing program.

Note that the specific embodiments or examples explained in the section of the best mode for carrying out the invention only clarifies technical contents of the invention. The invention should not be limited to such specific examples and interpreted in a narrow sense. It is possible to modify the invention in various ways within the spirit of the invention and the scope of claims.

### INDUSTRIAL APPLICABILITY

As described above, the service providing apparatus of the invention is suitable for efficiently performing crime prevention against an illegal intruder. Moreover, the service providing apparatus of the invention is also suitable for providing services suitable for a user in various service fields such as an operation explanation service for a machine tool, a service for automatically changing start time setting for a PC, a cooking provision service, and an accounting service for a rent-a-car.

1. A service providing apparatus characterized by comprising:
an operation sensor that judges whether a user has operated an access point in an object of operation by the user;
an access sensor that judges whether the user is present in a near area where the user could be present when the user operates the access point; and
control means that controls an operation of the service providing apparatus, and in that
the control means includes:
ID authentication means that performs ID authentication for the user on the basis of results of the judgment of the access sensor and the operation sensor; and
external processing determining means that selects a service from a plurality of services corresponding to at least one of the result of the judgment of the operation sensor, the result of the judgment of the access sensor and a result of the ID authentication of the ID authentication means and causes an external apparatus to execute the service.

2. A service providing apparatus according to claim 1, characterized in that
the object of operation by the user is a door for entering the house,
the access point is a door knob of the door and,
on the other hand, the operation sensor detects an operation of a key, which is used for unlocking the door, unlocking the door.

3. A service providing apparatus according to claim 1, characterized in that
the object of operation by the user is a door for entering the house,
the access point is a door knob of the door and,
on the other hand, the operation sensor is a pressure sensor that detects, when a key used for unlocking the door is inserted into a keyhole of the door, a force generated in a direction of the key from the keyhole.

4. A service providing apparatus according to claim 1, characterized in that
the object of operation by the user is a door for entering the house,
the access point is a door knob of the door and,
on the other hand, the operation sensor is a pressure sensor that detects, when a key used for unlocking the door is inserted into a keyhole and rotated, torque generated in the key.

5. A service providing apparatus according to any one of claims 1 to 4, characterized in that
the object of operation by the user is a door for entering the house,
the access point is a door knob of the door and,
on the other hand, the operation sensor includes:
a coil provided in the door knob;
magnetic field generating means that generates an induction field with the coil; and
detecting means that detects a magnetic force change in the induction field generated by the magnetic field generating means.

6. A service providing apparatus according to any one of claims 1 to 5, characterized by comprising radio communication means that is capable of switching width of an area, in which communication is possible, by switching an output of a radio wave used for communication, and in that
the ID authentication means performs ID authentication for the user by judging whether ID information acquired from an ID authentication terminal carried by a user by performing narrow area radio communication using the ID authentication terminal and the radio communication means is included in permission ID information recorded in the service providing apparatus and, on the other hand, when it is impossible to acquire proper ID information via the radio communication means, transmits information indicating that it is impossible to acquire proper ID information to the external apparatus by performing wide area radio communication using the radio communication means.

7. A service providing program, characterized by causing a computer to function as the control means in the service providing apparatus according to any one of claims 1 to 6.

8. A computer-readable recording medium, characterized by having recorded therein the service providing program according to claim 7.

9. A service providing method, characterized by comprising:
a first step of judging, with an operation sensor of a service providing apparatus, whether a user has operated an access point in an object of operation by the user;
a second step of performing, with ID authentication means of the service providing apparatus, ID authentication for the user based on a result of the judgment of the operation sensor; and
a third step of selecting, with external processing determining means of the service providing apparatus, a service from a plurality of services corresponding to at least one of the result of the judgment of the operation sensor, the result of the judgment of the access sensor and a result of the ID authentication of the ID authentication means and causing, with the external processing determining means, an external apparatus to execute the service.

10. (canceled)

11. (canceled)

12. A security management apparatus characterized by comprising:
an operation sensor that judges whether a user has operated an access point in an object of operation by the user;
an access sensor that judges whether the user is present in a near area where the user could be present when the user operates the access point; and
control means that controls an operation of the security management apparatus, and in that
the control means includes:
ID authentication means that performs ID authentication for the user on the basis of results of the judgment of the access sensor and the operation sensor; and
external processing determining means that selects a processing from a plurality of alarm processing corresponding to at least one of the result of the judgment of the operation sensor, the result of the judgment of the access sensor and a result of the ID authentication of the ID authentication means and causes an external apparatus to execute the alarm processing.

13. A security management method, characterized by comprising:
a first step of judging, with an operation sensor of a security management apparatus, whether a user has operated an access point in an object of operation by the user;
a second step of performing, with ID authentication means of the security management apparatus, ID authentication for the user based on a result of the judgment of the operation sensor; and
a third step of selecting, with external processing determining means of the security management apparatus, a processing from a plurality of alarm processing corresponding to at least one of the result of the judgment of the operation sensor, the result of the judgment of the access sensor and a result of the ID authentication of the ID authentication means and causing, with the external processing determining means, an external apparatus to execute the processing.
